(19) United States
(12) Patent Application Publication
(10) Pub. No.: US 2005/0134893 A1
(43) Pub. Date: Jun. 23, 2005

(54) Network image forming apparatus to notify error and operation controlling method thereof

(76) Inventor: Dong-hyeop Han, Madison, WI (US)

Correspondence Address: STANZIONE & KIM, LLP, 1740 N STREET, N.W., FIRST FLOOR, WASHINGTON, DC, 20036, US

(21) Appl. No.: 10/964,652

(22) Filed: Oct. 15, 2004

(30) Foreign Application Priority Data
Dec. 5, 2003 (KR) 2003-88194

(51) Int. Cl. G06F 3/12; G06F 11/00; G06F 9/00; G06F 15/00

(52) U.S. Cl. 358/1.14; 358/1.15; 715/705; 714/48; 710/15

(57) ABSTRACT

A network image forming apparatus includes a communication part to communication-interface with at least one user terminal, a print engine part to print print data transmitted from the at least one user terminal, an error detector to detect the presence of an error by checking an operating status of the print engine part and to generate an error code corresponding to the kind of the detected error, a URL information generator to generate URL information on a web page that provides solution information corresponding to the error code, and a controller to control the communication part to transmit the URL information generated by the URL information generator corresponding to the error code to the user terminal that has requested a print job.

### CROSS-REFERENCE TO RELATED APPLICATIONS

This application claims the benefit of Korean Patent Application No. 2003-88194, filed on Dec. 5, 2003, in the Korean Intellectual Property Office, the disclosure of which is incorporated herein by reference.

### BACKGROUND OF THE INVENTION

1. Field of the Invention

The present general inventive concept relates to an image forming apparatus, and more particularly, to a network image forming apparatus capable of notifying a user terminal in a connected network of an occurrence of an error, and an operation controlling method thereof.

2. Description of the Related Art

Image forming apparatuses, such as photocopiers, printer, facsimile machines, or multi function peripherals (MFP) that combine two or more of the following functions: copying, scanning, printing and faxing functions, commonly have a printing function. Printers are a most well-known image forming apparatus widely used for printing data transmitted from computers or scanners on paper.

Recently, the printer is networked to several user terminals via a wired or a wireless local area network (LAN) to enable remotely situated users to share the printer, thereby improving efficiency of the printer.

A network printing system is a system that connects one single network printer with a plurality of user terminals (e.g., personal computers), which requests the network printer a printing job (operation) through a network such as LAN. The network printer prints data transmitted from the user terminals linked through the LAN in a FIFO sequence. The establishment of such a network printing system can improve the efficiency of the printer and realize a cost-saving office automation system.

In a process of receiving print data from the user terminals or printing the received print data, errors may occur in the network printer. In this case, a conventional network printer displays a message through a manipulation panel provided on a printer body to inform of the occurrence of the errors.

However, the conventional network printing system has a problem in that the user has to go to the place where the network printer is located to check the occurrence of the error. Also, the conventional network printer just provides information on a cause of the error and cannot provide a solution to the error, which results in delay of a printing operation until the error is corrected.

### SUMMARY OF THE INVENTION

In order to solve the above and/or other problems, it is an aspect of the present general inventive concept to provide a network image forming apparatus capable of automatically notifying a user terminal, which has requested a printing job (operation), of an occurrence of an error when the error occurs in the image forming apparatus, and an operation controlling method thereof.

Additional aspects and advantages of the present general inventive concept will be set forth in part in the description which follows and, in part, will be obvious from the description, or may be learned by practice of the general inventive concept.

The above and/or other aspects of the present general inventive concept may be achieved by providing a network image forming apparatus that may include a communication part to communication-interface with at least one user terminal, a print engine part to print print data transmitted from the at least one user terminal, an error detector to detect the presence of an error by checking an operating status of the print engine part and generating an error code corresponding to the kind of the detected error, a URL information generator to generate URL information on a web page that provides solution information corresponding to the error code, and a controller to control the communication part to transmit the URL information generated by the URL information generator and corresponding to the error code to the user terminal that has requested a print job (operation).

In an aspect of the present general inventive concept, the network image forming apparatus can further include a storage part to store web site information of an external server that provides information on the network image forming apparatus, and a model serial number and firmware information of the network image forming apparatus.

In another aspect of the present general inventive concept, the URL information generator can generate the URL information based on the web site information of the external server, the model serial number, the firmware information, and error code information output from the error detector.

In yet another aspect of the present general inventive concept, the external server can provide the solution information corresponding to the error code through the web page.

In still another aspect of the present general inventive concept, the error detector can include a lookup table to store the error code information corresponding to the kinds of errors, and the error detector can detect the kind of error in a process of checking the operating status of the print engine part, can read out the error code corresponding to the kind of the error from the lookup table, and can output the read error code.

In another aspect of the present general inventive concept, the user terminal can receive the URL information from the network image forming apparatus and can drive a web browser to attempt to access to the web page corresponding to the URL information.

The above and/or other aspects of the present general inventive concept may also be achieved by providing an operation controlling method of a network image forming apparatus which prints print data transmitted from at least one user terminal, the method including performing a print job with respect to the print data corresponding to a print request signal, if an error has occurred during the performance of the print job, detecting the kind of the error and outputting an error code corresponding to the kind of the error, generating URL information on a web page that provides solution information corresponding to the error code, and transmitting the generated URL information to a user terminal which has requested the print (operation).

In an aspect of the present general inventive concept, the generating of URL information can include generating the URL information based on web site information of an external server that provides information on the network image forming apparatus, a model serial number and firmware information of the network image forming apparatus, and error code information.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a network printing system according to an embodiment of the present invention;

FIG. 2 is a flowchart illustrating an operation controlling method of the network printer of the networking printing system of FIG. 1 when an error occurs in the network printer according to another embodiment of the present general inventive concept;

FIG. 3 is a flowchart illustrating an operation controlling method of a user terminal of the networking printing system of FIG. 1 according to another embodiment of the present general inventive concept; and

FIGS. 4 through 6 are views illustrating examples of the result of executing URL information received from a network printer in the network printing system of FIG. 1 according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

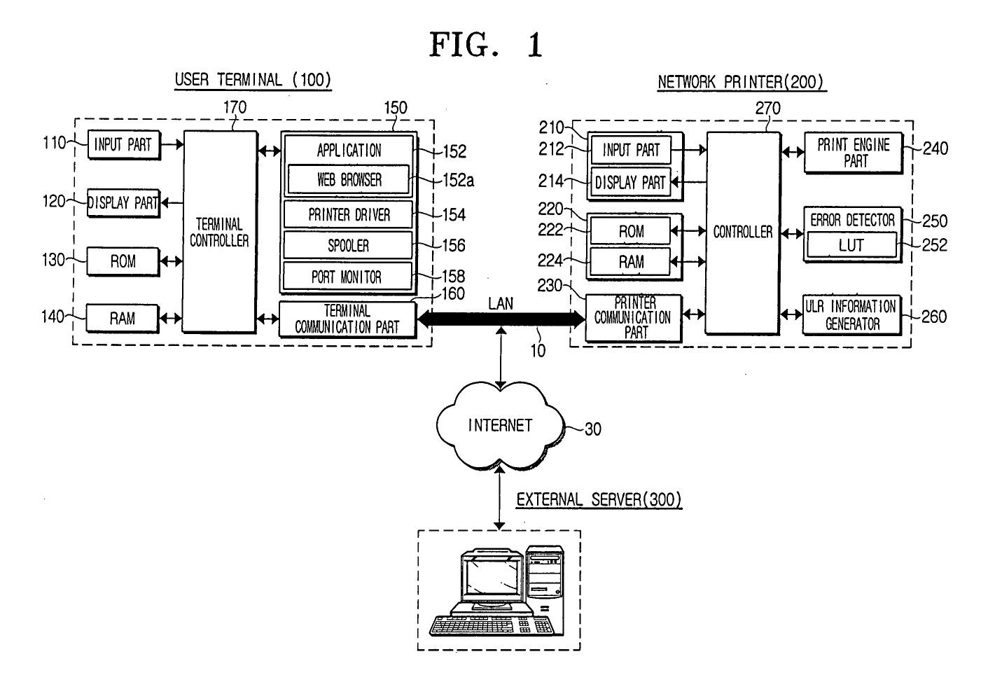

FIG. 1 is a block diagram showing a network printing system according to an embodiment of the present invention.

Referring to FIG. 1, the network printing system can be configured with a user terminal 100, a network printer 200, and an external server 300. The user terminal 100 can access the network printer 200 through a wired or a wireless local area network (LAN) 10 and also the external server 300 through the Internet 30. The external server 300 may be a printer manufacturer server that provides information on the network printer 200. Although not shown, a plurality of the user terminals 100 may be linked to the network printer 200 through the LAN 10.

The user terminal 100 can transmit print data to the network printer 200 through the LAN 10, and the network printer 200 can perform a print job (operation) with respect to the print data received from the user terminal 100. When an error occurs in the network printer 200 during a process of receiving the print data from the user terminal 100 or performing the print job with respect to the print data, the network printer 200 can generate URL (Uniform Resource Locator) information on a web page that provides information on the error. The generated URL information can be transmitted to the user terminal 100. The web page providing the URL information on the error is a web document that is created by the external server 300 to provide information on the network printer 200 on the web, such as the Internet 30.

The user terminal 100 may include an input part 110, a display part 120, a ROM 130, a RAM 140, a memory 150, a terminal communication part 160, and a terminal controller 170.

The input part 110 can transmit to the terminal controller 170 a key input signal generated by a user's key manipulation. The input part 110 may be a keyboard, a mouse and a touch panel.

The display part 120, such as a monitor, can display an operating status of the user terminal 100 according to a control of the terminal controller 170. In this embodiment, the display part 120 can display the web page to provide information on the error that has occurred in the network printer 200.

The ROM 130, such as a non-volatile memory, can store various control programs which are necessary to realize functions of the user terminal 100.

The RAM 140, such as a volatile memory, can temporarily store various data resulted from the execution of programs of the terminal controller 170.

The memory 150, such as a typical hard disk drive (HDD), can contain an application 152 driven in an operating system, a printer driver 154, a spooler 156, and a port monitor 158.

The application 152 may include document-editing programs and a web browser 152a that provides a way to search the web document written in a hypertext markup language (HTML). One example of the document-editing programs may be office programs developed by Microsoft, and one example of the web browser 152a may be Microsoft's Explorer or Netscape.

The printer driver 154 can translate the print data written by the document-editing program into a PCL (Printer Control Language) which is comprehensible by the network printer 200.

The spooler 156, which is a program provided in most operating systems, can manage spooling of the print data output from the printer driver 154. The print data temporarily stored in the spooler 156 can be transmitted to the port monitor 158 according to a processing speed of the network printer 200.

The port monitor 158 can be a program to control the terminal communication part 160 electrically and physically connected with the network printer 200. The port monitor 158 can control the print data to be transmitted from the spooler 156 to the network printer 200 through the terminal communication part 160. Also, the port monitor 158 can monitor the terminal communication part 160. When the receipt of the URL information from the network printer 200 is confirmed as a result of monitoring of the communication part 160, the port monitor 158 can call the web browser 152a stored in the application 152. Then, the display part 120 of the user terminal 100 can display the web page corresponding to the received URL information.

The terminal communication part 160 can perform communication interfacing operation with the network printer 200 linked through the LAN 10 and with the external server 300 linked through the Internet 30. The terminal communication part 160 may employ a NIC (Network Interface Card).

The terminal controller 170 can control overall operations of the user terminal 100 according to the control programs stored in the ROM 130. Upon receiving a print command about a document created by the document-editing program through the input device 110, the terminal controller 170 can control the printer driver 154, the spooler 156, the port monitor 158 and the terminal communication part 160 to transmit a print ready document (created document) to the network printer 200. The print data created by the document-editing program can be translated by the printer driver 154 into the PLC which is comprehensible by the network printer 200, and then transmitted to the network printer 200 through the spooler 156, the port monitor 158 and the terminal communication part 160.

Meanwhile, the network printer 200 may include a manipulation panel part 210, a memory 220, a printer communication part 230, a printer engine part 240, an error detector 250, a URL information generator 260 and a printer controller 270.

The manipulation panel part 210 can be provided with a plurality of manipulation keys that select and set functions supported by the network printer 200, an input part 212 to supply the printer controller 270 with key input signals corresponding to the manipulation keys, and a display part 214 to display an operating status of the network printer 200 according to a control of the printer controller 270.

The memory 220 can include a ROM 222 and a RAM 224.

The ROM 222, such as a non-volatile memory, can store various control programs which are necessary to realize the functions supported by the network printer 200. In this embodiment, the ROM 22 can store a model serial number of the network printer 200, firmware information (firmware version information), and URL information (e.g., http://www.samsung.com/) about a web site of the external server 300 that provides information on the network printer 200.

The RAM 224, such as a volatile memory, can temporarily store data which is generated during the execution of programs of the printer controller 270 and data which is generated during the printing of the received print data.

The printer communication part 230 can perform an operation of communication interfacing with the user terminal 100 linked through the LAN 10. The printer communication part 230 can receive the print data from the user terminal 100 through the LAN 10, and can also transmit the URL information generated by the URL information generator 260, which will be described below, to the user terminal 100.

The print engine part 240 can print the print data on recording paper according to the control of the printer controller 270.

The error detector 250 can monitor each operating status of the printer communication part 230 and the print engine part 240, and can detect an occurrence of an error in a process of receiving the print data from the user terminal 100 or performing the print job. When the error occurs in the network printer 200, the error detector 250 can detect the kind of the error and can transmit an error code corresponding to the detected error to the URL information generator 260.

The error detector 250 may have a lookup table (LUT) 252 containing error code information to be output to the URL information generator 260 corresponding to the error code and the kind of the detected error.

Table 1 illustrates one example of the LUT 252 stored in the error detector 250

TABLE 1

| Kind of Error | Error Code |
|---|---|
| JAM | 1234 |
| TONER LOW | 1235 |
| PAPER EMPTY | 1236 |

The URL information generator 260 can generate the URL information on the web page that provides information corresponding to the error code transmitted from the error detector 250 under the control of the printer controller 270. The URL information on the web page that provides the information on the present error can be generated based on the URL information on the web site of the external server 300 providing the information about the network printer 200, and the model serial number of the network printer 200, the firmware version information, all of which are stored in the ROM 222, and the error code information outputted from the error detector 250.

More specifically, when an error code 1234 corresponding to the paper jam is received from the error detector 250, the URL information generator 260 can extract from the ROM 222 the URL information of the external server 300 (e.g., http://www.samsung.com/), the model serial number of the network printer 200 (e.g., ML-7300), and the firmware version (e.g., 1.03). The URL information generator 260 can generate the URL information on the web page (e.g., “http://www.samsung.com/printer/ML-7300/1.03/error/1234”) that provides the information on the present error, based on a combination of the extracted information with the error code outputted from the error detector 250. Here, “/printer/ML-7300/1.03/error/1234” denotes a directory existing in the external server 300. A sign ‘/’ can be used to designate a name of a directory required by a file system having a hierarchical directory structure.

Table 2 illustrates one example of the URL information on the web page generated by the URL information generator 260 corresponding to the error code.

TABLE 2

| Error Code | URL Address of Web page |
|---|---|
| 1234 | http://www.samsung.com/printer/ML-7300/1.03/error/1234 |
| 1235 | http://www.samsung.com/printer/ML-7300/1.03/error/1235 |
| 1236 | http://www.samsung.com/printer/ML-7300/1.03/error/1236 |

Referring to Table 2, the URL addresses on the web page generated by the URL information generator 260 can be different according to the kinds of errors that have occurred in the network printer 200. The URL information on the web page generated by the URL information generator 260 corresponds to the error codes and is temporarily stored in the RAM 224.

The printer controller 270 can control overall operations of the network printer 200 according to the control programs stored in the ROM 222. More specifically, when the print data is received from the user terminal 100 through the printer communication part 230, the printer controller 270 can control the print engine part 240 to perform the print job with respect to the received print data. When the error code corresponding to the error detected by the error detector 250 is received during the print job of the print engine part 240, the print controller 270 can control the URL information generator 260 to generate the URL information on the web page corresponding to the error code, and can control the print communication part 230 to transmit the generated URL information to the user terminal 100.

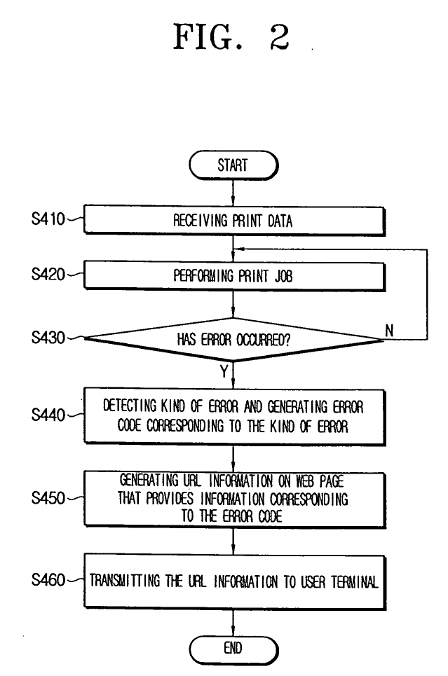

Hereinafter, an operation controlling method of the network printer 200 and the user terminal 100 when the error occurs in the network printer 200 will be described with reference to FIGS. 2 to 6.

FIG. 2 is a flowchart illustrating the operation controlling method of the network printer 200 of FIG. 1 when the error occurs.

Referring to FIGS. 1 and 2, when the print data is received from the user terminal 100 through the printer communication part 230 (operation S410), the printer controller 270 can control the print engine part 240 to perform the print job with respect to the received print data (operation S420). The error detector 250 can determine whether the error has occurred during the print job of the print engine part 240 (operation S430).

In operation S430, if it is determined that the error occurs or has occurred in the network printer 200 during the print job, the error detector 250 can detect the kind of the error, read out an error code corresponding to the kind of the error from the LUT 252, and output the read error code to the URL information generator 260 (operation S440).

Upon receiving the error code that corresponds to the kind of the present error detected by the error detector 250, the URL information generator 260 can generate the URL information on the web page that provides the information on the error code (operation S450). The URL information generated by the URL information generator 260 can be based on the URL information on the web site of the external server 300, the model serial number of the network printer 200, the firmware version information, all of which are stored in the ROM 222, and the error code information received from the error detector 250.

As the URL information on the web page that provides a solution to the present error is generated, the printer controller 270 can control the print communication part 230 to transmit the generated URL information to the user terminal 100 (operation S460).

Although the error occurs in the process of performing the print job according to this embodiment, this should not be considered as limiting. The operations from S440 to S460 can be automatically repeated when any error occurs or has occurred in the network printer 200.

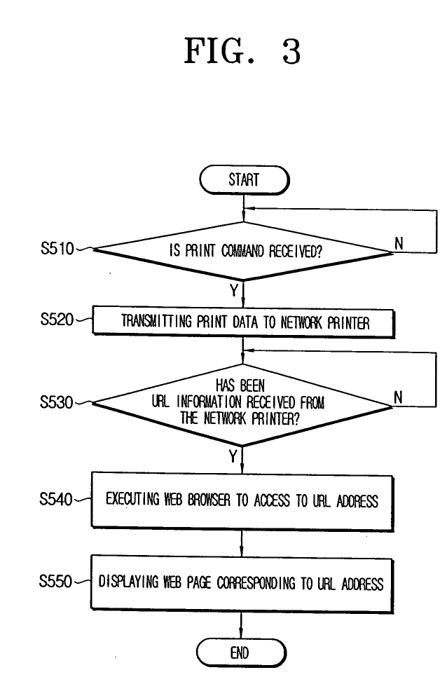

FIG. 3 is a flowchart illustrating an operation controlling method of the user terminal 100 of FIG. 1.

Referring to FIGS. 1 through 3, a user inputs the print command to output the document created by the document-editing program to the network printer 200 (operation S510). Corresponding to the print command, the printer driver 154 can translate the print data into data which is comprehensible by the network printer 200. The print data translated by the printer driver 154 can be transmitted to the network printer 200 through the spooler 156, the port monitor 158, and the terminal communication part 160 (operation S520).

The port monitor 158 can monitor whether predetermined information (URL information) is received or has been received from the network printer 200 during the transmission of the print data to the network printer 200 through the terminal communication part 160 or after the complete transmission of the print data (operation S530).

When the URL information has been received from the network printer 200, the port monitor 158 can determine that the error has occurred in the network printer 200. If the URL information on the error has been received from the network printer 200 before all of the print data is transmitted to the network printer 200, the port monitor 158 can control the terminal communication part 160 to stop the transmission of the print data to the network printer 200.

In operation S530, if it is determined that the URL information is received or has been received from the network printer 200 through the terminal communication part 160, the port monitor 158 can invoke the web browser 152a to enter the URL information received from the network printer 200 (operation S540).

When the user enters the received URL by invoking the web browser 152a, the display device 120 can display the web page that provides solution information on the error code generated by the network printer 200.

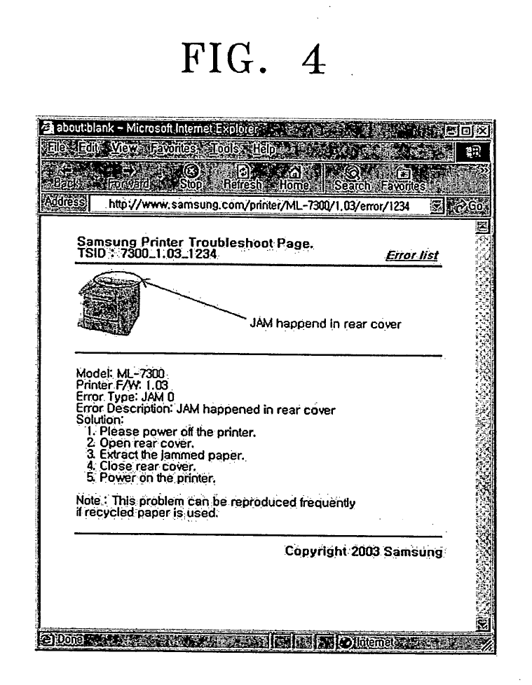

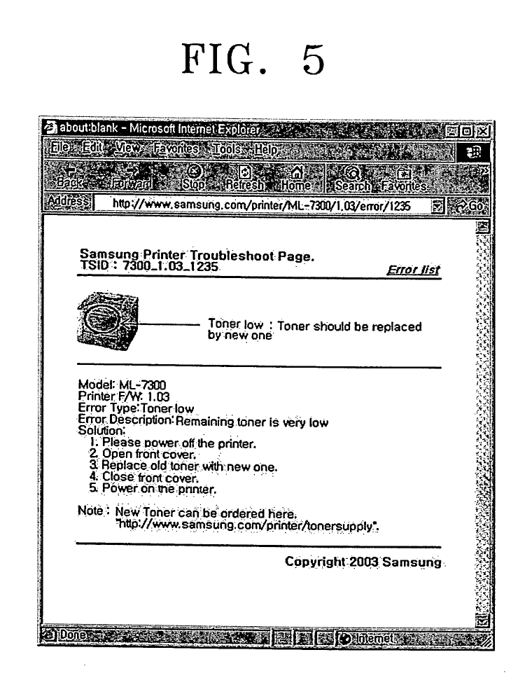

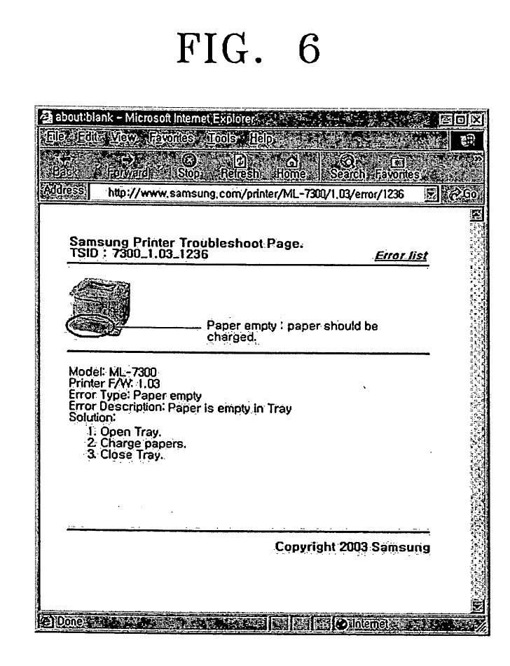

FIGS. 4 through 6 illustrate examples of a window resulted from the execution of the URL information received from the network printer 200. FIG. 4 illustrates a result of executing the URL information corresponding to a paper jam error, FIG. 5 illustrates the result of executing the URL information corresponding to a toner low error, and FIG. 6 illustrates a result of executing the URL information corresponding to a paper empty error.

As shown in FIGS. 4 to 6, the web page corresponding to the URL information received from the network printer 200 displays the model serial number of the network printer, the firmware version, the kind of the an error, error description and the solution. Accordingly, the user can be aware of the kind of the error, a cause of the error and the solution through the web page displayed on the display device 120.

Although the network printer 200 was described in this embodiment by way of an example, this should not be considered as limiting. The present general inventive concept can be applied to any network apparatus that is enabled to access to the network, such as a network multi function peripheral or a network scanner.

As described above, the network printer 200 can transmit to the user terminal 100, which has requested the print job, the information on the web page displaying the solution to the error. Based on received information, the user can be informed of the kind of error, causes of the error, and the solution of the error. That is, the user can check the occurrence of the error without directly going to the place where the network printer 200 is located. Also, since the solution information to the error is provided, the time for correcting the error can be reduced. Accordingly, the efficiency of the network printer 200 and user's convenience can be improved.

Since the information on the error is provided from the manufacturer server that provides the information on the network image forming apparatus, the memory of the image forming apparatus can be efficiently used and most recently updated information can be always provided.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A network image forming apparatus, comprising:
a communication part to communication-interface with at least one user terminal;
a print engine part to print print data transmitted from the at least one user terminal;
an error detector to detect an error of the print engine by checking an operating status of the print engine part and to generate an error code corresponding to the kind of the detected error;
a URL information generator to generate URL information on a web page that provides solution information corresponding to the error code information; and
a controller to control the communication part to transmit the URL information generated by the URL information generator corresponding to the error code information to the user terminal that has requested a print operation.

2. The network image forming apparatus as claimed in claim 1, further comprising:
a storage part for to store web site information of an external server that provides information on the network image forming apparatus including model serial number information and firmware information of the network image forming apparatus,
wherein the URL information generator generates the URL information based on the web site information of the external server, the model serial number information, the firmware information, and the error code information output from the error detector.

3. The network image forming apparatus as claimed in claim 2, wherein the web page provides the solution information corresponding to the error code information through the external server.

4. The network image forming apparatus as claimed in claim 1, wherein the error detector comprises:
a lookup table to store the error code information corresponding to the kinds of errors including the detected error,
wherein the error detector detects the kind of the error by checking the operating status of the print engine part, reads out the error code information corresponding to the kind of the error from the lookup table and outputs the read error code information.

5. The network image forming apparatus as claimed in claim 4, wherein the user terminal receives the URL information from the network image forming apparatus and drives a web browser to access the web page corresponding to the URL information.

6. An operation controlling method of a network image forming apparatus which prints print data transmitted from at least one user terminal, the method comprising:
performing a print operation with respect to the print data corresponding to a print request signal;
if an error has occurred during the performing of the print operation, detecting the kind of the error and outputting error code information corresponding to the kind of the error;
generating URL information on a web page that provides solution information corresponding to the error code information; and
transmitting the generated URL information to a user terminal which has requested the print job.

7. The method as claimed in claim 6, wherein the generating of the URL information comprises generating the URL information based on web site information of an external server that provides information on the network image forming apparatus, a model serial number and firmware information of the network image forming apparatus, and the error code information.

8. The method as claimed in claim 7, wherein the web page providing the solution information corresponding to the error code information is provided by the external server.

9. A network printing system comprising:
a printer having an error detector to detect an error of the printer and to generate error code information on the error of the printer, and having an information generator to generate the error code information through a web page.

10. The network printing system as claimed in claim 9, wherein the printer further comprises a memory to store printer information,
wherein the information generator generates the printer information through the web page.

11. The network printing system as claimed in claim 10, wherein the printer information comprises at least one of a model serial number or firmware of the printer,

12. The network printing system as claimed in claim 10, wherein the printer is connectable to an external source through a wire or wireless communication to receive at least one portion of the printer information from the external source.

13. The network printing system as claimed in claim 12, wherein the wire or wireless communication comprises Internet.

14. The network printing system as claimed in claim 12, wherein the external source is a manufacturer of the printer.

15. The network printing system as claimed in claim 12, wherein the printer comprises:
a memory to store a web site address of the external source,
wherein the printer accesses the external source using the web site address through the Internet to download the at least one portion of the printer information.

16. The network printing system as claimed in claim 12, wherein the printer contacts the external source when the error detector detects the error of the printer.

17. The network printing system as claimed in claim 9, wherein the printer is connectable to an external source through a wire or wireless communication to receive solution information corresponding to the error of the printer from the external source, and the information generator generates the solution information together with the error code information through the web page.

18. The network printing system as claimed in claim 17, further comprising:
a user terminal connectable to the printer through a wire or wireless communication to generate print data to be printed in the printer, and the error detector detects the error of the printer during a printing operation of printing the print data.

19. The network printing system as claimed in claim 17, wherein the printer is connectable to the user terminal through a local area network.

20. The network printing system as claimed in claim 9, wherein the information generator generates solution information corresponding to the error code information through the web page.

21. The network printing system as claimed in claim 20, wherein the solution information comprises a solution to fix the error of the printer.

22. The network printing system as claimed in claim 20, wherein the error comprises a paper jam, a low toner, and a paper empty state, and a characteristic of a component of the printer, and the solution information comprises a solution to solve the error.

23. The network printing system as claimed in claim 9, further comprising:
a user terminal connected to the printer,
wherein the user terminal generates a display signal corresponding to the web page.

24. The network printing system as claimed in claim 23, wherein the user terminal generates print data to be printed in the printer, and the error detector detects the error when the printer receives the print data from the user terminal.

25. The network printing system as claimed in claim 9, wherein the information generator generates URL information including the error code information through the web page.

26. A network printing system comprising:
a user terminal to generate print data to be printed in a printing operation, to receive error information relating to the printing operation of the printer through a web page, and to generate a display signal corresponding to the error information.

27. The network printing system as claimed in claim 26, wherein the user terminal is connectable to a printer through a wire or wireless communication, and the printer receives the print data from the user terminal, detects an error of the printer relating to the printing the print data, and generates the error information corresponding to the error through the web page.

28. The network printing system as claimed in claim 26, wherein the user terminal is connected to the printer through a local area network.

29. The network printing system as claimed in claim 26, wherein the user terminal receives solution information corresponding to the error information through the web page.

30. The network printing system as claimed in claim 26, wherein the user terminal accesses the web page to receive the error information.

31. The network printing system as claimed in claim 26, wherein the user terminal automatically accesses the web page when outputting the print data.

32. A network printing system comprising:
a printer having an error detector to detect an error of the printer and to generate error code information on the error, and having an information generator to generate the error code information through a web page; and
a user terminal to generate print data to be printed in a printing operation in the printer, to receive the error code information relating to the printing operation through the web page, and to generate a display signal corresponding to the error information.

33. A method of a network printing system, the method comprising:
detecting an error of a printer;
generating error code information on the error; and
generating the error code information through a web page.

34. A method of a network printing system, the method comprising:
generating print data to be printed in a printing operation;
receiving error information relating to the printing operation through a web page; and
generating a display signal corresponding to the error information.

35. A method of a network printing system, the method comprising:
detecting an error of a printer;
generating error code information on the error of the printer;
generating the error code information through a web page;
generating print data to be printed in a printing operation;
receiving error code information relating to the printing operation through a web page; and
generating a display signal corresponding to the error code information.
